(19) United States
(12) Patent Application Publication
(10) Pub. No.: US 2006/0029510 A1
(43) Pub. Date: Feb. 9, 2006

(54) Motor-driven Roots compressor

(76) Inventors: Katsutoshi Shiromaru, Kariya-shi (JP); Toshiro Fujii, Kariya-shi (JP); Tatsuyuki Hoshino, Kariya-shi (JP)

Correspondence Address: Morgan & Finnegan, L.L.P., 3 World Financial Center, New York, NY, 10281-2101, US

(21) Appl. No.: 10/997,351

(22) Filed: Nov. 24, 2004

(30) Foreign Application Priority Data
Nov. 27, 2003 (JP) 2003-397870

(51) Int. Cl. F01C 1/18; F01C 1/24; F03C 2/00

(52) U.S. Cl. 418/205; 418/206.1

(57) ABSTRACT

A motor-driven Roots compressor includes a drive shaft driven by a motor and a driven shaft connected to a drive shaft through a timing gear. A pair of rotors is respectively fixed to the drive shaft and the driven shaft. The rotors are rotated so that the compressor draws and discharges working fluid. The compressor also includes a casing having a plurality of shells which define a motor chamber for accommodating the motor, a gear chamber for accommodating the timing gear and a rotor chamber for accommodating the pair of rotors. A refrigerant passage is formed in at least one of the shells of the motor chamber and the gear chamber for flowing the working fluid therein. At least one of the motor and the timing gear is cooled by the working fluid in the refrigerant passage.

### BACKGROUND OF THE INVENTION

The present invention relates to a motor-driven Roots compressor and, more particularly, to a structure for cooling a motor for the Roots compressor and a timing gear therein.

In a Roots compressor, generally, a driven shaft is connected to a drive shaft through a timing gear, and a pair of rotors is respectively connected to the drive shaft and the driven shaft. The rotors are rotated in opposite directions for the Roots compressor to draw and discharge gas and, therefore, heat is generated in the timing gear. For cooling the timing gear, Unexamined Japanese Patent Application Publication No. 2001-248581 proposes an arrangement wherein cooling water flows in the casing of the Roots compressor.

However, the use of a water-cooling type cooling device as in the above-cited prior art will enlarge and complicate the compressor because provision must be made for the cooling water. Meanwhile, the Roots compressor, which is used as a pump for supplying fuel gas to a fuel cell system, is required to be made compact. Thus, a motor-driven Roots compressor has been developed which is equipped with a small-sized motor as a drive source. Thus, a small-sized motor-driven Roots compressor that cools a timing gear and a motor is desired.

The present invention is directed to a motor-driven Roots compressor that cools a timing gear and a motor and is small in size and simple in structure.

### SUMMARY OF THE INVENTION

According to the present invention, a motor-driven Roots compressor includes a drive shaft driven by a motor and a driven shaft connected to a drive shaft through a timing gear. A pair of rotors is respectively fixed to the drive shaft and the driven shaft. The rotors are rotated so that the compressor draws and discharges working fluid. The compressor also includes a casing having a plurality of shells which define a motor chamber for accommodating the motor, a gear chamber for accommodating the timing gear and a rotor chamber for accommodating the pair of rotors. A refrigerant passage is formed in at least one of the shells of the motor chamber and the gear chamber for flowing the working fluid therein. At least one of the motor and the timing gear is cooled by the working fluid in the refrigerant passage.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a cross-sectional view of a motor-driven Roots compressor according to a first preferred embodiment;

FIG. 2 is a cross-sectional view of the motor-driven Roots compressor taken along the line I-I in FIG. 1;

FIG. 3 is a cross-sectional view of a motor-driven Roots compressor according to a second preferred embodiment;

FIG. 4 is a cross-sectional view of the motor driven Roots compressor taken along the line II-II in FIG. 3;

FIG. 5 is a cross-sectional view of a motor driven Roots compressor according to an alternative embodiment; and

FIG. 6 is a cross-sectional view of the motor driven Roots compressor taken along the line III-III in FIG. 5.

### DETAILED DESCRIPTION OF THE PREFERRED EMBODIMENTS

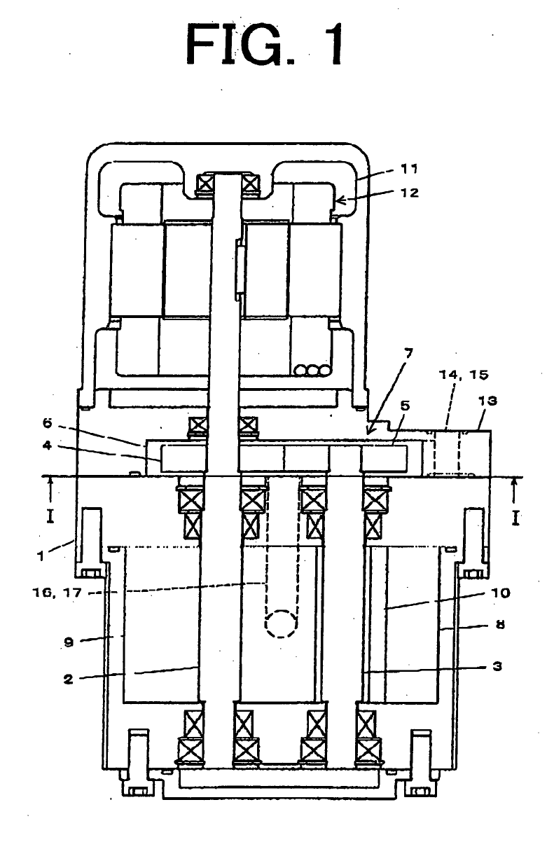

The following will describe first and second preferred embodiments according to the present invention with reference to FIGS. 1 through 4. The first preferred embodiment will be now described. FIG. 1 shows the internal structure so of a motor-driven Roots compressor of the first preferred embodiment. The motor-driven Roots compressor has a casing 1 in which a drive shaft 2 and a driven shaft 3 are disposed rotatably and in parallel to each other. The casing 1 has a plurality of outer shells which define therein a gear chamber 6, a rotor chamber 8 and a motor chamber 11. The gear chamber 6 is located between the rotor chamber 8 and the motor chamber 11. A drive gear 4 is fixed to the middle portion of the drive shaft 2 and a driven gear 5 is fixed to the upper end portion of the driven shaft 3, as seen in FIG. 1, and these gears 4, 6 are engaged with each other in the gear chamber 6, thereby forming a timing gear 7. The lower end portions of the drive shaft 2, as seen in FIG. 1, and the driven shaft 3 extend through the rotor chamber 8. A first rotor 9 and a second rotor 10 are respectively fixed to the drive shaft 2 and the driven shaft 3 in the rotor chamber 8. The upper end portion of the drive shaft 2, as seen in FIG. 1, extends through the motor chamber 11. A motor 12 is accommodated in the motor chamber 11, and the upper portion of the drive shaft 2 in the motor chamber 11 serves as the output shaft of the motor 12.

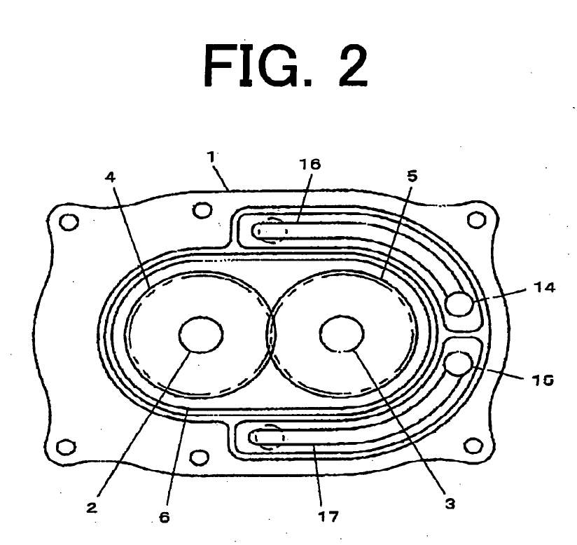

The casing 1 has an eccentric portion 13 that is located adjacent to the gear chamber 6 and extends laterally further than the outer periphery of the casing 1 adjacent to the motor chamber 11. An inlet port 14 and an outlet port 15 are formed in the eccentric portion 13, are located adjacent to each other. and extend in the axial direction of the compressor. The inlet port 14 and the outlet port 15 communicate with the rotor chamber 8 through a suction passage 16 and a discharge passage 17 as refrigerant passages of the present invention, respectively. As shown in FIG. 2, the suction passage 16 and the discharge passage 17 extend from the inlet port 14 and the outlet port 15 through the outer shell of the gear chamber 6 in the casing 1, respectively, so as to partially surround the gear chamber 6. Referring back to FIG. 1, the suction passage 16 and the discharge passage 17 further extend axially to the rotor chamber 8 in the outer shell of the rotor chamber 8.

The following will describe the operation of the compressor of the first preferred embodiment. When the drive shaft 2 is rotated by the motor 12, the driven shaft 3 is rotated in the opposite direction of the drive shaft 2 through the drive gear 4 and the driven gear 5 and the first and second rotors 9, 10 are rotated in opposite directions, accordingly. Thus, working fluid is drawn into the rotor chamber 8 from the inlet port 14 through the suction passage 16, while the compressed working fluid is discharged from the rotor chamber 8 through the discharge passage 17 to the outlet port 15, from which the fluid is further discharged out of the compressor. Since the suction passage 16 and the discharge passage 17 extend in the easing 1 so as to partially surround the gear chamber 6 as described above, the timing gear 7 in the gear chamber 8 is cooled by the working fluid flowing in the suction passage 16 and the discharge passage 17. Thus, heating of the timing gear 7 during the operation of the motor-driven Roots compressor is restricted.

There is formed a dead space above and adjacent to the eccentric portion 13 of the casing 1 as seen in FIG. 1. However, in view of the arrangement of the inlet and outlet ports 14, 15 which are formed axially in the eccentric portion 13 of the casing 1, the dead space may be effectively utilized by arranging tubes to and from the inlet and outlet ports 14, 15 in such dead space, which makes it possible to install the compressor in a small limited space.

Hydrogen is usable as the working fluid in the first preferred embodiment. Hydrogen has a low coefficient of kinematic viscosity. Thus, although the refrigerant passage, namely, the suction passage 16 and the discharge passage 17 are provided in the casing 1 for cooling the gear chamber 6 and hydrogen flows therein, pressure loss of the working fluid is not substantially increased. Therefore, hydrogen is appropriate for use as the working fluid in the first preferred embodiment.

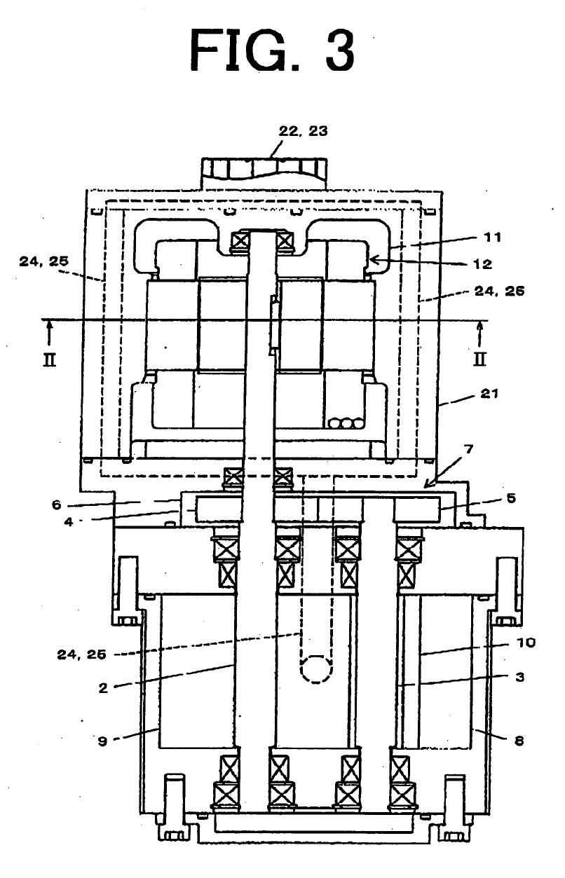

The following will describe the second preferred embodiment. FIG. 3 shows the internal structure of a motor-driven Roots compressor according to the second preferred embodiment. This second preferred embodiment differs from the first preferred embodiment primarily in that an inlet port 22 and outlet port 23 are adjacently disposed at the upper end (one axial end) of a casing 21 that forms the outer shell of the motor chamber 11 as seen in FIG. 3. Since the arrangement of the gear chamber 9 between the motor chamber 11 and the rotor chamber 8 and the structures of the drive shaft 2, the driven shaft 3, the timing gear 7, the first rotor 9, the second rotor 10 and the motor 12 are substantially the same as the first preferred embodiment, the description thereof is omitted.

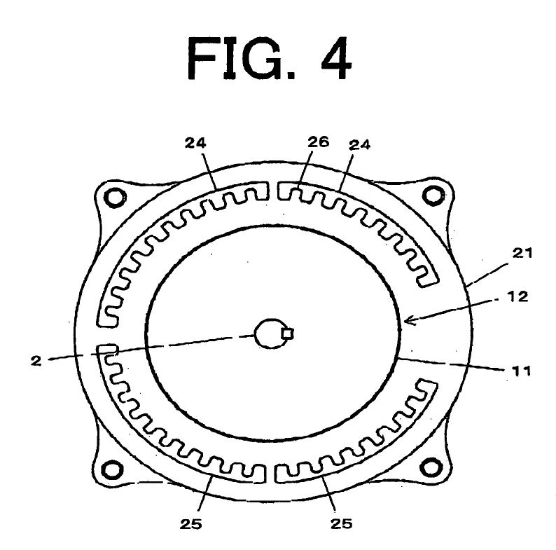

As mentioned above, the inlet port 22 and the outlet port 23 are formed in the upper end of the casing 21 adjacent to the motor chamber 11 and located adjacent to each other. The inlet port 22 and the outlet port 23 extend in the axial direction of the compressor and respectively communicate with the rotor chamber 8 through a suction passage 24 and a discharge passage 25, which extend in the outer shell of the rotor chamber 8, as refrigerant passages of the present invention. As shown in FIGS. 3 and 4, the suction passage 24 and the discharge passage 25 respectively extend from the inlet port 22 and the outlet port 23 through the outer shell of the motor chamber 11 in the casing 21 in the axial direction of the compressor so as to partially surround the motor chamber 11. The suction passage 21 and the discharge passage 26 further extend to the rotor chamber 8 in the casing 21. As shown in FIG. 4, the casing 21 has a number of radiation fins 26 protruding radially into the suction passage 24 and the discharge passage 25.

The following will describe the operation of the compressor of the second preferred embodiment. When the drive shaft 2 is rotated by the motor 12, the driven shaft 3 is rotated in the opposite direction of the drive shaft 2 through the drive gear 4 and the driven gear 5 and the first and second rotors 9, 10 are rotated in opposite direction. Thus, working fluid is drawn into the rotor chamber 8 from the inlet port 22 through the suction passage 24, while the compressed working fluid is discharged from the rotor chamber 8 through the discharge passage 25 to the outlet port 23, from which the fluid is further discharged out of the compressor. Since the suction passage 16 and the discharge passage 17 extend in the casing 1 so as to partially surround the motor chamber 11 as described above, the motor 12 in the motor chamber 11 is cooled by the working fluid flowing in the suction passage 16 and the discharge passage 17. Thus, heating of the motor 12 during the operation of the motor-driven Roots compressor is restricted. Specifically, the fins 26 protruding in the suction passage 24 and the discharging passage 25 serve to promote the cooling.

Since the motor 12 is cooled as described above, it is possible to use a small-sized motor as the motor 12, so that the motor-driven Roots compressor is made compact in size.

The inlet port 22 and the outlet port 23 are formed in the casing 21 at one end of the motor chamber 11 and extend in axial direction of the compressor. Thus, the arrangement of pipes is made simpler, which makes it possible to install the compressor in a small limited space. Furthermore, hydrogen is usable as the working fluid as in the above first preferred embodiment. Because of the same reason as described with reference to the above first preferred embodiment, hydrogen is appropriate for use as the working fluid in the second preferred embodiment.

According to the present invention, the following alternative embodiments may be practiced.

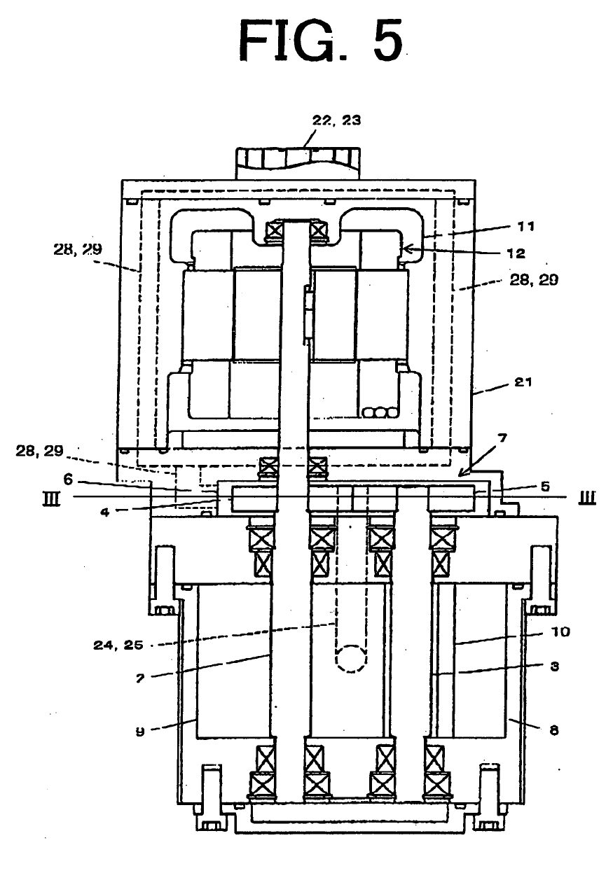

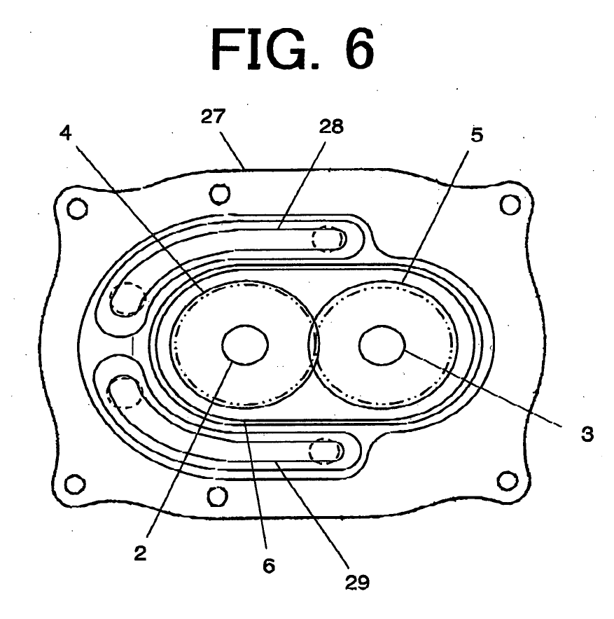

The refrigerant passage is formed in the casing 1 so as to partially surround the gear chamber 6 in the first preferred embodiment and in the casing 21 so as to partially surround the motor chamber 11 in the second preferred embodiment for cooling the timing gear 7 and the motor 12, respectively. In an alternative embodiment of the invention, however, the refrigerant passage is formed in the outer shells of the gear chamber 6 and the motor chamber 11 in the casing 1 for cooling the timing gear 7 and the motor 12. Specifically, as shown in FIGS. 5 and 6, a suction passage 28 and a discharge passage 29 as refrigerant passages are formed in a casing 27 so as to partially surround both the gear chamber 6 and the motor chamber 11 for cooling the timing gear 7 and the motor 12.

In the first and second preferred embodiments, the suction passage 16, 24 and the discharge passage 17, 25 are arranged in parallel, and the inlet port 14, 22 and the outlet port 15, 23 are located adjacent to each other. According to the invention, however, either one of the suction passage 16 and the discharge passage 17 will do for cooling the timing gear 7 in the case of the first preferred embodiment, and either one of the suction passage 24 and the discharge passage 25 will do for cooling the motor 12 in the case of the second preferred embodiment. Alternatively, the inlet port 14 and the outlet port 15, or the inlet port 22 and the outlet port 23 are located at a further spaced distance.

The motor-driven Roots compressors of the first and second preferred embodiments are installed for service such that their drive shafts 2 lie in horizontal direction. However, the motor-driven Roots compressor is installed such that the drive shaft 2 is located vertically, or the motor-driven Roots compressor is Installed with its drive shaft Inclined at any angle.

In the above first and second preferred embodiments, various kinds of fluids other than hydrogen and air are also usable as the working fluid. It is noted that hydrogen has a resistance smaller than that of air, so that pressure loss is smaller when hydrogen is used. Thus, when hydrogen is used as the working fluid, the suction passage, the discharge passage and pipes are formed with a smaller diameter, thereby making it possible to construct the compressor smaller in size.

The present invention has been described as applied to a motor-driven Roots compressor that is used as hydrogen pumps or air pumps for supplying fuel gas to a fuel cell body in the fuel cell system. However, the present invention is also applicable to a Roots compressor for other purposes.

The present examples and embodiments are to be considered as illustrative and not restrictive, and the invention is not to be limited to the details given herein but may be modified within the scope of the appended claims.

What is claimed is:

1. A motor-driven Roots compressor comprising;
a drive shaft driven by a motor;
a driven shaft connected to a drive shaft through a timing gear;
a pair of rotors respectively fixed to the drive shaft and the driven shaft, the rotors being rotated so that the compressor draws and discharges working fluid;
a casing having a plurality of shells which define a motor chamber for accommodating the motor, a gear chamber for accommodating the timing gear and a rotor chamber for accommodating the pair of rotors; and
a refrigerant passage formed In at least one of the shells of the motor chamber and the gear chamber for flowing the working fluid therein, wherein at least one of the motor and the timing gear is cooled by the working fluid in the refrigerant passage.

2. The motor-driven Roots compressor according to claim 1, wherein the gear chamber is located between the motor chamber and the rotor chamber.

3. The motor-driven Roots compressor according to claim 2, wherein the casing has an eccentric portion that is located adjacent to the gear chamber and that extends laterally further than an outer periphery of the casing adjacent to the motor chamber, at least one of an inlet port and an outlet port being formed in the eccentric portion.

4. The motor-driven Roots compressor according to claim 3, wherein the refrigerant passage interconnects each of the inlet port and the outlet port with the rotor chamber, respectively.

5. The motor-driven Roots compressor according to claim 2, wherein at least one of an inlet port and an outlet port is formed in an axial end of the casing adjacent to the motor chamber.

6. The motor-driven Roots compressor according to claim 5, wherein the refrigerant passage interconnects each of the inlet port and the outlet port with the rotor chamber, respectively.

7. The motor-driven Roots compressor according to claim 1, wherein the refrigerant passage is formed in the casing so as to at least partially surround the gear chamber.

8. The motor-driven Roots compressor according to claim 1, wherein the refrigerant passage is formed in the casing so as to at least partially surround the motor chamber.

9. The motor-driven Roots compressor according to claim 8, wherein the casing has radiation fins protruding into the refrigerant passage.

10. The motor-driven Roots compressor according to claim 1, wherein the refrigerant passage is formed in the casing so as to at least partially surround both the motor chamber and the gear chamber.

11. The motor-driven Roots compressor according to claim 1, wherein the working fluid is hydrogen.

12. The motor-driven Roots compressor according to claim 1, wherein the compressor is used as a pump for supplying fuel gas to a fuel cell system.
